(19) United States
(12) Patent Application Publication
(10) Pub. No.: US 2022/0400455 A1
(43) Pub. Date: Dec. 15, 2022

(54) METHOD FOR SYNCHRONISING A COMMUNICATION SYSTEM BASED ON THE RETRANSMISSION OF DATA

(71) Applicants: UNIVERSITE GRENOBLE ALPES, Saint Martin D'Heres (FR); INSTITUT POLYTECHNIQUE DE GRENOBLE, Grenoble (FR); CENTRE NATIONAL DE LA RECHERCHE SCIENTIFIQUE, Paris (FR); UNIVERSITE SAVOIE MONT BLANC, Chambery (FR)

(72) Inventors: Jules GARSAULT, Grenoble (FR); Emil NOVAKOV, Saint Nasaire Les Eymes (FR); Ghislaine MAURY, Echirolles (FR)

(21) Appl. No.: 17/776,763

(22) PCT Filed: Nov. 12, 2020
(86) PCT No.: PCT/EP2020/081906

§ 371 Date: May 13, 2022

(30) Foreign Application Priority Data
Nov. 13, 2019 (FR) FR1912645

(51) Int. Cl. H04W 56/00

(52) U.S. Cl. CPC H04W 56/003; H04W 56/001

(57) ABSTRACT

The present disclosure relates to the field of synchronising a radio frequency (RF) communication system based on the repeated transmission of data at the transmitter and the use of a method for the time synchronous averaging of this data at the receiver. The proposed communication technique uses the fact that the data signal is periodically repeated, without requiring the use of synchronisation data external to the data to be communicated. It enables phase and frequency synchronisation to be maintained when the received signals are very noisy, and even when they have a signal-to-noise ratio of less than 1 or even a negative signal-to-noise ratio (in dB). A significant improvement in the processing gain of the method for time synchronous averaging is advantageously achieved.

### TECHNICAL FIELD OF THE INVENTION

The invention relates to the field of synchronising a radio frequency (RF) communication system. More particularly, synchronisation is based on the repeated transmission of data at the transmitter and the time synchronous averaging thereof at the receiver. One particularly advantageous application concerns the communication of short data signals in a noisy environment.

### PRIOR ART

The invention can be applied to most radio communication systems (LoRa, SigFox, conventional systems, etc.). It will be particularly advantageous for low-speed applications, as well as for communications in narrow bandwidths for which the transmission power is limited by telecommunications regulators (ETSI, FCC, etc.). Such bands are, for example, the ISM (Industrial, Scientific and Medical) bands, which are frequency bands used for industrial, scientific, medical, domestic or similar applications.

Focus will in particular be on improving the quality, range and reliability of RF links. The invention will be applied to carry out software updates, establish communications in noisy, dense or isolated areas, and enable bi-directional instrumentation and control over equipment. It more particularly concerns applications such as the remote reading of water, gas or electricity meters or any type of equipment that transmits or receives information at low speed and spaced apart in time. For example, each meter will ideally be equipped with a radio transmitter (with a bi-directional link that allows updates to be carried out) in order to transmit information to enable a meter reading.

Time synchronous averaging (TSA) is a powerful technique for processing periodic signals that is capable of improving the signal-to-noise ratio (SNR) to the point of extracting data from a periodic signal, the power whereof can be lower than the noise superimposed thereon during its RF transmission. The potential gain from this method of communication is theoretically very high. However, achieving this gain requires achieving and maintaining synchronisation between the transmitter and receiver. More particularly, not only phase synchronisation, but also frequency synchronisation must be achieved and maintained. In general, the gain achieved thanks to this method is severely limited by the clock offset between the receiver and transmitter (i.e. by the difficulties of ensuring frequency synchronisation between the receiver and transmitter).

One example of a method for synchronising a radio frequency communication system based on the retransmission of data is known in particular from the international patent document No. 2015/150488 A1. At the transmitter, the method is based on the transmission of a data block comprising a preamble word that is known to the receiver, followed by a data word repeated in an identical manner several times. At the receiver, the method is based on the detection of the preamble word to synchronise the receiver to the transmitter, and then on the time synchronous averaging of the repetitions of the data word to retrieve the data transmitted. The effectiveness of this technique is limited by the synchronisation method implemented.

One purpose of the present invention is thus to propose a method for synchronising a radio frequency communication system based on the retransmission of data that is improved, particularly in terms of sensitivity and per channel in terms of link budget, which is capable of increasing the communication range under certain propagation conditions. Another purpose of the present invention is to propose a synchronisation method that allows data to be transmitted even when the noise is stronger than the signal, which is optionally of a very low amplitude, on which it is superimposed, i.e. in the event of a signal-to-noise ratio of less than 1, or even a negative signal-to-noise ratio (in dB). Another purpose of the present invention is to enable bidirectional communications, as used for the Internet of Things (IoT), while keeping the signal power level in accordance with the standards imposed, for example, by the European Telecommunications Standards Institute (ETSI) or the Federal Communications Commission (FCC).

Other purposes, features and advantages of the present invention will appear upon reading the following description and examining the accompanying drawings. It is understood that other advantages can be incorporated therein.

### SUMMARY OF THE INVENTION

In order to achieve this objective, according to a first aspect, the present invention provides for a method for processing digital data to be transmitted in the form of a radio frequency signal from a transmitter to a receiver, the method comprising the following steps of:
a) Grouping the digital data into a so-called original data block with a determined bit size,
b) Generating, from the original data block, a plurality of so-called secondary data blocks, each secondary data block being obtained by permutation, according to an algorithm and determined parameters, of the digital data grouped into the original block, the algorithm preferably being such that each secondary block generated is different from the other secondary blocks of the plurality, and
c) Constructing a data frame comprising a succession of a determined number of secondary blocks from the plurality of secondary blocks previously generated, the frame thus constructed defining the radio frequency signal to be transmitted.

According to a second aspect, the invention provides for a method for processing a radio frequency signal received by a receiver, the radio frequency signal having been defined from a data frame comprising a succession of a determined number of so-called secondary data blocks, each secondary data block having been obtained by permutation, according to an algorithm and determined parameters, of digital data previously grouped into a so-called original block having a determined bit size, the method comprising the following steps of:
a) Sampling the radio frequency signal with an oversampling frequency defined by the receiver,
b) Recording the samples as they are taken into a buffer memory,
c) From among a series of recorded samples having a size at least equal to the bit size of each secondary block that is multiplied by the number of secondary blocks in the frame and a presumed number of samples per bit selected from a set comprising a nominal value corresponding to a nominal oversampling frequency of the receiver, at least one value lower than said nominal value and at least one value higher than said nominal value:
   i. Selecting a sequence of samples from a given sample at regular intervals of size equal to said presumed number of samples per bit,
   ii. Splitting the selected sequence of samples into a plurality of so-called tertiary blocks of samples, the number of tertiary blocks being equal to the number of secondary blocks in the frame,
   iii. For each tertiary block, generating a so-called quaternary block of samples by permuting the samples of the tertiary block with one another, this permutation being the inverse of that previously carried out on the original block to obtain the corresponding secondary block, then
   iv. Dividing the quaternary blocks into at least two groups,
   v. Computing, per group, a so-called average block from the quaternary blocks,
   vi. Computing a correlation measure between each pair of previously computed average blocks,
   vii. Saving the one or more previously computed correlation measures by associating each correlation measure with a given index of the sample from which the selection was made and with the presumed number of samples per bit, then
   viii. Repeating steps i to vii using at least one other sample different to the sample from which the previous selection was made,
d) For at least one further value of the presumed number of samples per bit selected from among the set comprising a nominal value corresponding to a nominal oversampling frequency of the receiver, at least one value lower than said nominal value and at least one value higher than said nominal value, repeating step c, so as to save the computed correlation measures, associating each correlation measure with the index of the sample from which the selection was made and with the presumed number of samples per bit considered,
e) Determining which of the saved correlation measures corresponds to a higher correlation between average blocks, and retrieving the index of the sample and the presumed number of samples per bit associated with this measure, then
f) Identifying the sequence of samples selected from the index of the sample associated with this measure and at regular intervals of size equal to the presumed number of samples per bit associated with this measure, as being representative of a succession of original data blocks corresponding to the succession of secondary data blocks from which the data frame was constructed.

It should be noted in this case that:
said nominal value corresponding to the nominal oversampling frequency of the receiver can depend on the presumed oversampling frequency; and/or
each sequence of selected samples has the bit size of the frame; and/or
each tertiary block comprises a number of samples equal to the number of bits in each secondary block; and/or
said inverse permutation is defined according to the algorithm and the determined parameters that allowed the corresponding secondary block to be obtained; and/or
the computation of the so-called average block from the quaternary blocks is carried out by arithmetically averaging their nth samples (by adding their nth samples to one another, then dividing the result of each addition by the number of quaternary blocks in the group), each average block thus comprising a number of averaged samples equal to the number of samples in each quaternary block.

The communication technique described hereinabove provides for the injection, at the transmitter, and the use, at the receiver, of information in addition to the data to be communicated, in order for synchronisation between the transmitter and receiver. The proposed communication technique is based not only on the retransmission of the same data by the transmitter, but also on the permutation of the data blocks before the communication thereof. In this way, precise phase and frequency synchronisation is obtained, which ultimately allows the data to be communicated to be retrieved by time synchronous averaging, even when the data are significantly noisy.

In an optional manner, the invention according to its first aspect can further have at least any one of the following features:

The data frame can comprise only said succession of secondary blocks, and be free of other data such as data constituting a preamble word;

The secondary data blocks of the data frame are preferably adjacent to one another in pairs;

The step of generating a plurality of secondary data blocks can comprise the sub-steps of:
Splitting the original data block into at least three sub-blocks such that at least one sub-block comprises at least two bits, with at least two sub-blocks potentially comprising a different number of bits, and
Permuting at least two of the sub-blocks with one another, these sub-steps preferably being repeated while varying the number of sub-blocks and/or the number of bits in at least two sub-blocks.

In an optional manner, the invention according to its second aspect can further have at least any one of the following features:

Steps i to vii are preferably repeated using a sample following the sample from which the previous selection was made; and/or

Each group of quaternary blocks preferably comprises the same number of quaternary blocks; and/or

The repetition of steps i to vii is preferably carried out using every other sample from among the samples of the series of recorded samples; and/or

The repetition of step c) is preferably carried out for each of the other values in the set comprising a nominal value corresponding to a nominal oversampling frequency of the receiver, at least one value lower than said nominal value and at least one value higher than said nominal value.

According to an alternative embodiment of the second aspect of the invention, the iterative loop on the given sample from which the sequence of samples is selected and the iterative loop on the number of samples presumed per bit are traversed in a different manner to those set out hereinabove.

More particularly, according to this alternative embodiment, the method of the invention can be described as follows:

A method for processing a radio frequency signal received by a receiver, the radio frequency signal having been defined from a data frame comprising a succession of a determined number of so-called secondary data blocks, each secondary data block having been obtained by permutation, according to an algorithm and determined parameters, of digital data previously grouped into a so-called original block having a determined bit size, the processing method comprising the following steps of:
a) Sampling the radio frequency signal with an oversampling frequency defined by the receiver,
b) Recording the samples as they are taken into a buffer memory,
c) From among a series of recorded samples having a size at least equal to the bit size of each secondary block that is multiplied by the number of secondary blocks in the data frame and a presumed number of samples per bit selected from a set comprising a nominal value corresponding to a nominal oversampling frequency of the receiver, at least one value lower than said nominal value and at least one value higher than said nominal value:
   i. Selecting a sequence of samples from a given sample at regular intervals of size equal to said presumed number of samples per bit,
   ii. Splitting the selected sequence of samples into a number of so-called tertiary blocks of samples equal to the number of secondary blocks in the data frame,
   iii. For each tertiary block, generating a so-called quaternary block of samples by permuting the samples of the tertiary block with one another, this permutation being the inverse of that carried out on the original block to obtain the corresponding secondary block, then
   iv. Dividing the quaternary blocks into at least two groups,
   v. Computing, per group, a so-called average block from the quaternary blocks,
   vi. Computing a correlation measure between each pair of previously computed average blocks,
   vii. Saving the one or more previously computed correlation measures by associating each correlation measure with an index of the sample from which the selection was made and with the presumed number of samples per bit, then
   viii. Repeating steps i to vii, for at least one other value of the presumed number of samples per bit different to that with which the previous selection was made,
d) Repeating step c from at least one other sample different to the sample previously considered, so as to save the computed correlation measures, associating each correlation measure with the index of the sample from which step c is repeated and with the presumed number of samples per bit considered,
e) Determining which of the saved correlation measures corresponds to a higher correlation between average blocks, and retrieving the index of the sample and the presumed number of samples per bit associated with this correlation measure, then
f) Identifying the sequence of samples selected from the index of the sample associated with this correlation measure and at regular intervals of size equal to the presumed number of samples per bit associated with this correlation measure, as being representative of a succession of original data blocks corresponding to the succession of secondary data blocks from which the data frame was constructed.

In an optional manner, the invention according to the alternative embodiment of the second aspect thereof can further have at least any one of the following features:

Steps i to vii are preferably repeated for each of the other values in the set comprising a nominal value corresponding to a nominal oversampling frequency of the receiver, at least one value lower than said nominal value and at least one value higher than said nominal value; and/or

Each group of quaternary blocks preferably comprises the same number of quaternary blocks; and/or

Steps c) is preferably repeated using a sample following the sample from which the previous selection was made; and/or

The repetition of step c) is preferably carried out using every other sample from among the samples of the series of recorded samples.

A person skilled in the art will recognise that, in addition to this alternative embodiment, the above-mentioned loops can be traversed in various other ways.

In an optional manner, the invention according to its second aspect and alternative embodiment can further have at least any one of the following features:

Preferably, the given sample from which the sequence of samples is selected is initially the first sample recorded in the buffer memory; and/or

When the quaternary blocks are divided into more than two groups, the step of computing at least one correlation measure between each pair of previously computed average blocks further comprises computing a correlation measure by averaging the correlation measures between pairs of average blocks; and/or

Step f can be followed by a step of determining the digital data by time synchronous averaging for the sequence of samples identified in step f. The digital data thus determined are presumed to correspond to those that were grouped into the original block.

Further aspects of the present invention each relate to a computer program product comprising instructions, which when carried out by at least one processor, execute at least the steps of each of the processing methods described hereinabove.

According to another aspect thereof, the invention further relates to a communication system comprising at least a transmitter configured to implement the processing method according to the first aspect of the invention and at least a receiver configured to implement the processing method according to the second aspect of the invention or according to the alternative embodiment thereof.

### BRIEF DESCRIPTION OF THE FIGURES

The aims, purposes, features and advantages of the invention will be better understood upon reading the detailed description given of one embodiment thereof, which is illustrated by means of the following accompanying drawings, in which:

FIG. 1 diagrammatically shows an example embodiment of the processing method according to the first aspect of the invention;

FIG. 2 diagrammatically shows an example embodiment of the step of generating a plurality of secondary data blocks by permutation of the digital data of the original block;

FIG. 3 shows the example embodiment shown in FIG. 1 in a different manner from FIG. 1;

FIG. 4 diagrammatically shows a part of the receiver implemented according to the second aspect of the invention or according to the alternative embodiment of the second aspect and an example embodiment of a first part of the processing method according to the second aspect of the invention or the alternative embodiment thereof;

FIG. 5 diagrammatically shows an example embodiment of a part of the processing method according to the second aspect of the invention and according to the alternative embodiment thereof;

FIG. 6 diagrammatically shows an example embodiment of a part of the processing method according to the second aspect of the invention and according to the alternative embodiment thereof;

FIG. 7 diagrammatically shows an embodiment of the step of computing an average block from quaternary blocks grouped into the same group;

FIG. 8 diagrammatically shows an embodiment of the steps of the processing method according to the second aspect of the invention and according to the alternative embodiment thereof, these steps resulting in computing a correlation measure between two average blocks from two groups of quaternary blocks;

FIG. 9 diagrammatically shows an example embodiment of a step of computing a correlation measure of the processing method according to the second aspect of the invention and according to the alternative embodiment thereof, when the quaternary blocks are divided into four separate groups;

FIG. 10 is a graph showing the evolution of correlation measures carried out as a function of the index of the sample from which the selection of the sequence of samples was carried out according to an example embodiment of the processing method according to the second aspect of the invention and according to the alternative embodiment thereof;

The four figures FIG. 11A to 11D are graphs showing the evolution of correlation measures carried out for four different values of the number of samples presumed per bit according to an example embodiment of the processing method according to the second aspect of the invention and according to the alternative embodiment thereof;

FIG. 12 diagrammatically shows an embodiment of the communication system according to one aspect of the invention;

FIG. 13 is a flowchart representing an example embodiment of the processing method according to the first aspect of the invention;

FIG. 14 is a flowchart representing an example embodiment of the processing method according to the second aspect of the invention;

FIG. 15 is a flowchart representing an example embodiment of the processing method according to an alternative embodiment of the second aspect of the invention;

FIG. 16 is a flowchart representing, in a different manner to FIG. 14, another example embodiment of the processing method according to the second aspect of the invention; and

FIGS. 17A and 17B are graphs, each representing the evolution of correlation measures made for three values of the number of samples presumed per bit, these values being the same for both graphs, the graph in FIG. 17A having been obtained for a signal-to-noise ratio of 10 dB and the graph in FIG. 17B having been obtained for a signal-to-noise ratio of −10 dB.

The drawings are provided by way of example and are not intended to limit the scope of the invention. They constitute diagrammatic views intended to ease the understanding of the invention and are not necessarily to the scale of practical applications.

### DETAILED DESCRIPTION OF THE INVENTION

“Oversampling” is understood to mean the process of sampling a radio frequency signal at a sampling frequency that is significantly higher than the Nyquist rate. Theoretically, a bandwidth-limited signal can be perfectly reconstructed if it is sampled at or above the Nyquist speed. The Nyquist rate is defined as being twice the highest frequency component of the signal to be reconstructed.

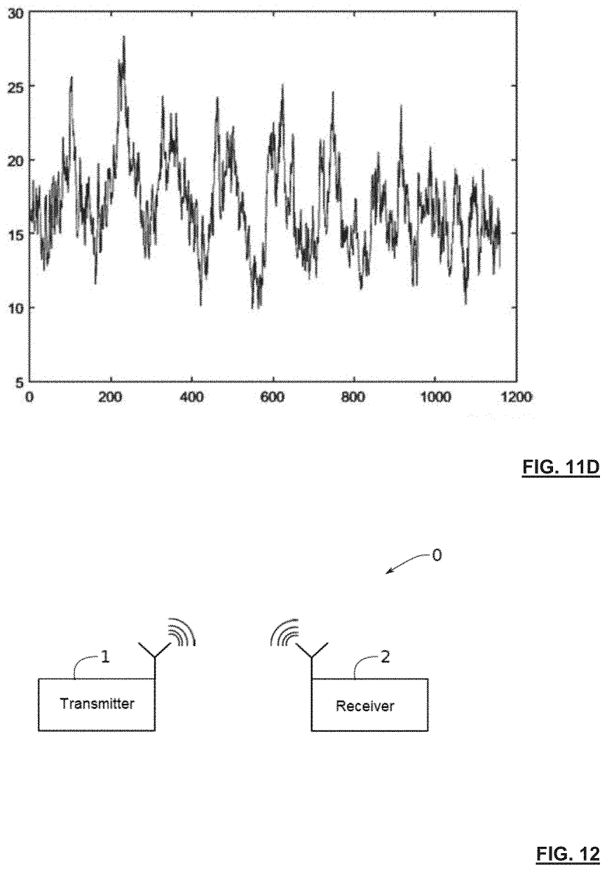

With reference to FIG. 12, the present invention relates to a method for synchronising a communication system 0 based on the retransmission of data. Communication is achieved by radio frequency transmission between a transmitter 1 and a receiver 2. The synchronisation method is divided into two digital data processing methods, the first 100 being implemented at the transmitter 1 and the second 200 being implemented at the receiver 2.

The paragraphs hereinbelow will firstly describe one embodiment of the processing method 100 according to the first aspect of the invention implemented at the transmitter 1, then will describe one embodiment of the processing method 200 according to the second aspect of the invention implemented at the receiver 2. These two processing methods 100 and 200 will be seen to be clearly linked to one another by one and the same inventive step.

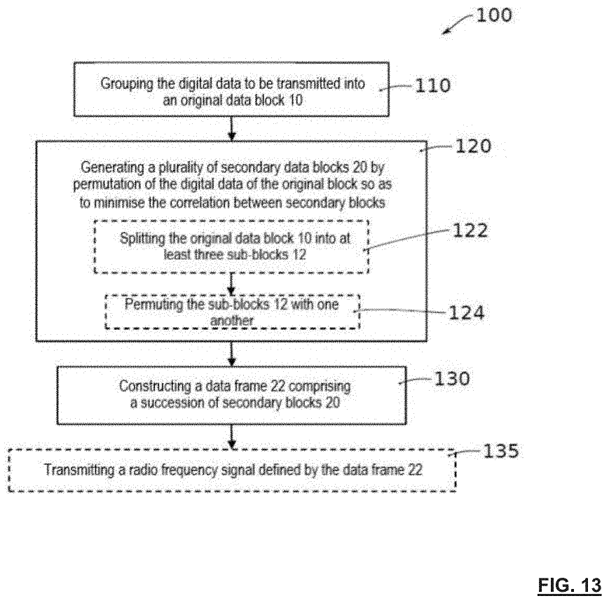

With reference to FIGS. 1, 2, 3 and 13, the processing method 100 according to the first aspect of the invention consists in processing digital data intended to be transmitted 135 by radio frequency signal from the transmitter 1 to the receiver 2.

In a known manner, the digital data to be transmitted 135 are thus firstly converted into an analogue signal by means of a digital-to-analogue converter of the transmitter 1.

According to one embodiment of the processing method 100, the digital data are processed prior to being transmitted 135 in the manner described hereinbelow.

The digital data to be transmitted 135 are firstly grouped 110 into a so-called original data block 10 with a determined bit size. The bit size of the original data block 10 is, in relation to the intended applications of the synchronisation method according to the invention, relatively limited. Typically, the original data block 10 comprises between 64 and 1024 bits, preferably between 64 and 128 bits.

Using the original data block 10, the method 100 comprises generating 120 a plurality of so-called secondary data blocks 20, so as to construct 130 a data frame 22 composed of the plurality of secondary data blocks 20.

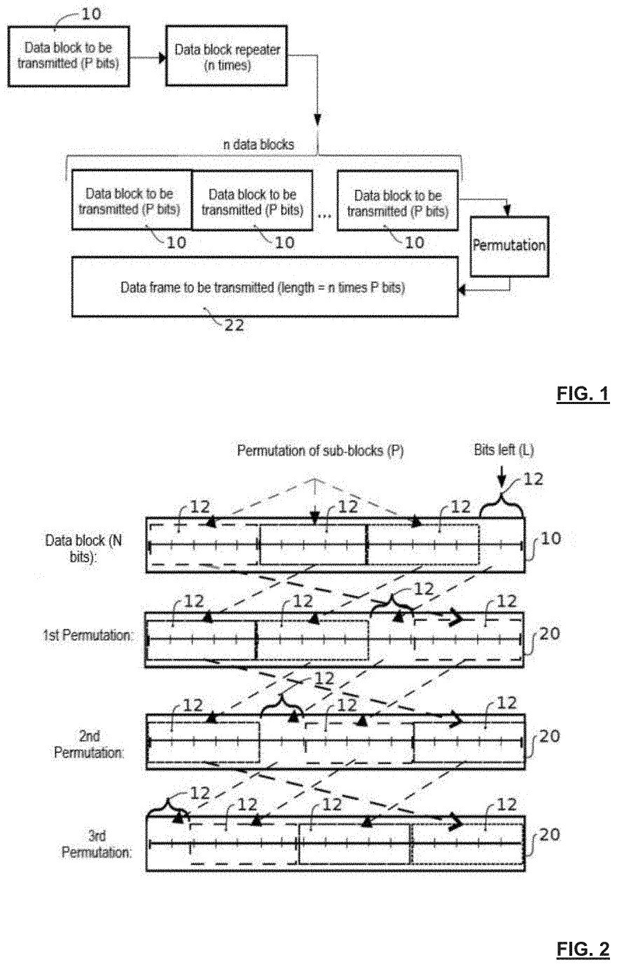

Each secondary data block 20 is more particularly obtained by permuting the digital data comprised in the original data block 10. For this purpose, the transmitter 1 can comprise processing means, such as a microprocessor, configured to implement a predetermined algorithm potentially involving a certain number of parameters. This so-called permutation algorithm is specifically designed to minimise the correlation between the secondary blocks 20 generated 120. One example implementation of such an algorithm is described hereinbelow with reference to FIG. 2. However, the synchronisation method according to the invention is not limited to a specific permutation algorithm. A person skilled in the art will be able to select, among the known algorithms allowing grouped digital data 110 in a data block to be permuted, that which allows a satisfactory, or even optimal, decorrelation to be obtained between the secondary data blocks 20 generated 120. In order to achieve optimal decorrelation of the secondary data blocks 20 with one another, the algorithm and its parameters will preferably be selected such that each secondary block 20 generated 120 is different from the other secondary blocks 20 of the plurality.

As will become apparent from the description of the processing method 200 implemented at the receiver 2, the data frame 22 constructed 130 can advantageously consist only of the secondary blocks 20 generated 120. In other words, the data frame 22 can advantageously be free of any digital data other than those resulting from permutations of the digital data of the original block 10. It is at least in this that the processing method 100 according to the first aspect of the invention differs from the known synchronisation methods of the prior art, the latter being disadvantageously based on the addition of synchronisation data to the data to be transmitted. Such synchronisation data external to the digital data to be transmitted thus increases the quantity of data to be transmitted, which is effectively prejudicial when communicating in narrow bandwidths.

With reference to FIG. 2, one example embodiment of the step of generating 120 the plurality of secondary blocks 20 is described hereinbelow. The original data block 10 to be transmitted is firstly split 122 into at least three sub-blocks 12. As shown at the top of FIG. 2, an original twenty-bit data block can be split 122 into four sub-blocks 12: three sub-blocks 12 each comprising six bits, and a fourth sub-block 12 comprising the remaining two bits of the twenty bits of the original data block 10. Different splits into sub-blocks 12 of the original data block 10 can be successively considered to allow for the generation 120 of an increased plurality of secondary data blocks 20. It should, however, be noted that in the present example embodiment, at least one sub-block preferably comprises at least two bits. More specifically, if each sub-block could contain only a single bit, the splitting step 122 would be superfluous. As shown in the example given, it should be noted that at least two sub-blocks 12 can comprise a different number of bits.

The permutation algorithm shown in FIG. 2 is of particular interest in that it reduces itself, once splitting 122 has been carried out, to rewriting the sub-blocks in the register in such a way that they are offset from one another. More particularly, in the example shown, the first sub-block of the original data block 10 is rewritten at the end of a space in the register, the size whereof is equal to the size of the original data block 10. The other sub-blocks are written into said space upstream of the position of the first offset sub-block and in the order of their writing in the original data block 10. In this way, a first secondary block 20 is obtained. A second sub-block 20 can be obtained, as shown in FIG. 2, by permuting the sub-blocks 12 of the first sub-block 20 obtained with one another, then a third sub-block 20 can be obtained by permuting the sub-blocks 12 of the second sub-block 20 obtained with one another. The advantage of this algorithm is that it considers the permutation of the sequences of bits that each sub-block 12 comprises, rather than the permutation of individual bits with one another, thereby helping to minimise the correlation between the secondary blocks 20 generated 120.

The number of secondary blocks 20 to be generated 120 depends on how many times the digital data must be repeated in order to be effectively transmitted to the receiver 2, this number of repetitions in turn depending essentially on the radio frequency transmission conditions between the transmitter 1 and the receiver 2. It must thus be adapted on a case-by-case basis, bearing in mind that the synchronisation method according to the present invention makes it possible to extend the limit in terms of the number of repetitions of the synchronisation processes of the prior art. Typically, under ordinary communication conditions, the synchronisation method according to the invention remains efficient for a number of repetitions comprised between 2 and 32, preferably greater than 6, or even comprised between 6 and 16, whereas the synchronisation methods of the prior art tend to diverge as soon as the number of repetitions is greater than or equal to 5. It should be noted that the number of repetitions is not necessarily imposed, or even known, a priori. More specifically, the digital data of the original block 10 can be repeatedly transmitted a certain number of times and only a limited number of these repetitions can be considered at the receiver 2. It is of course preferable, particularly in the context of communications in narrow bandwidths, to precisely adapt the number of data repetitions to each individual case. This adaptation is presumed to be within the ordinary skills of a person skilled in the art, for example by carrying out routine tests.

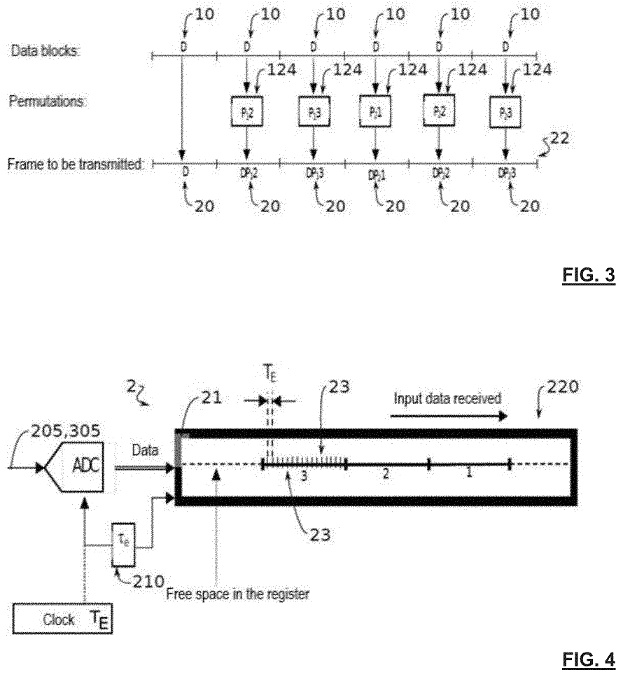

The processing method 100 can be imaged as shown in FIGS. 1 and 3. Once the original data block 10 to be transmitted has been defined, the data block is repeated n times and the n original data blocks 10 obtained are concatenated with one another, then each original data block 10 is permuted as described hereinabove, so as to obtain the data frame 22. The latter 22 is thus composed of a succession of a determined number of secondary blocks 20 adjacent in pairs, this number being equal to the number of repetitions of the original data block 10. The way in which the permutations 124 are noted in FIG. 3 reflects the fact, already stated hereinabove, that different splits 122 into sub-blocks 12 of the original data block 10 are successively possible, which will allow the generation 120 of an increased plurality of secondary data blocks 20. It should be noted here that, given the limited number of repetitions that are required and sufficient to transmit the digital data, generating 120 the plurality of secondary data blocks 20 such that each generated secondary block is different from the other secondary blocks in the plurality is not a challenge.

It should be noted that, as shown in FIG. 3, the original data block 10 can advantageously form part of the data frame 22 to be transmitted. In other words, each sub-block 20 making up the data frame 22 need not necessarily be different from the original data block 10, which also applied for each secondary block 20 which need not be different from the other secondary blocks 20.

It is thus apparent from the above that the data frame 22 is determined by the example embodiment of the processing method 100 according to the first aspect of the invention. It is thus known that this data frame 22 can be converted into an analogue signal, and more particularly into a radio frequency signal to be transmitted 135 from the transmitter 1 to the receiver 2 of the communication system 0.

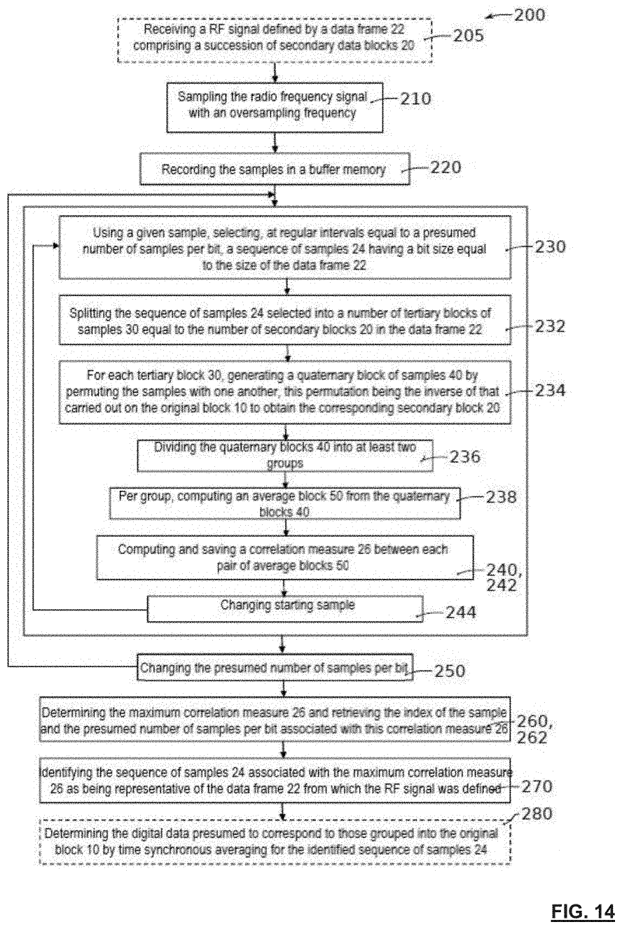

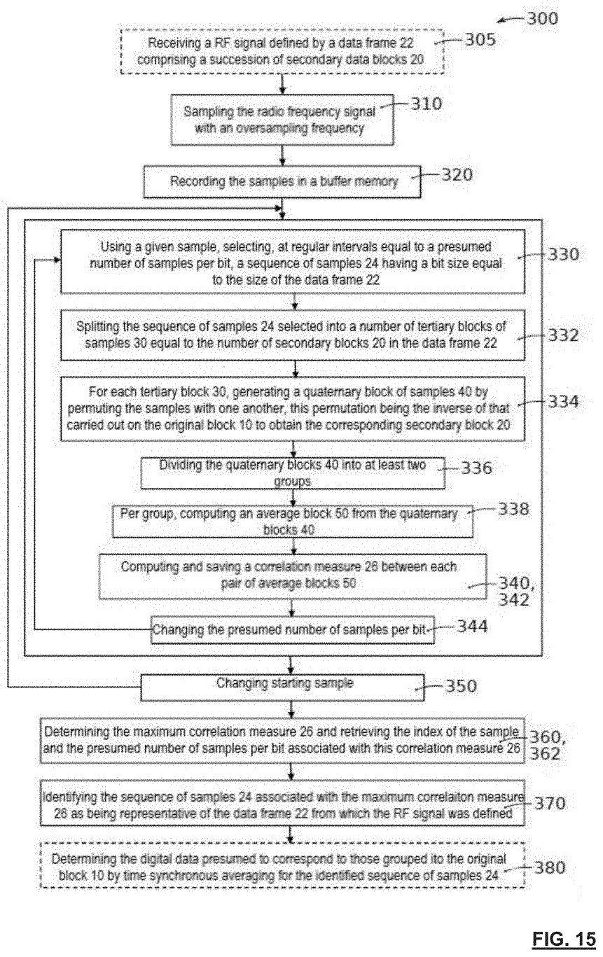

With reference to FIGS. 4 to 12, 14 and 16, the processing method 200 according to the second aspect of the invention, implemented at the receiver 2, will now be described.

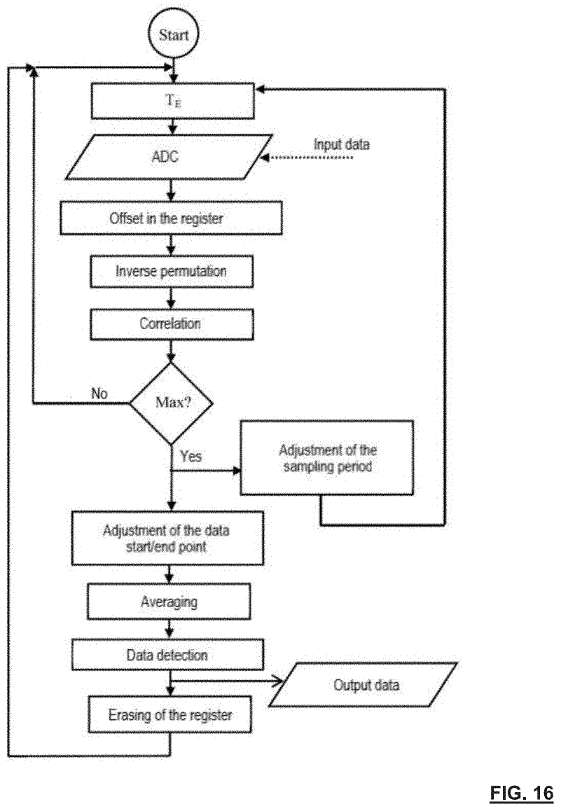

In any case, the radio frequency signal transmitted 135 is received 205 by the receiver 2. The receiver 2 comprises, as shown in FIG. 4, an analogue-to-digital converter configured to convert the radio frequency signal received 205 into digital, and preferably binary, data. This step is also shown in FIG. 16. More particularly, the analogue-to-digital converter operates with a delay that is required for conversion, this delay being commonly referred to as the conversion time, and being denoted as τₑ in FIG. 4.

Moreover, the analogue-to-digital converter operates with a clock frequency defined by its electronic components. This clock frequency is proportional to, or equal to, the so-called sampling frequency at which the radio frequency signal is converted into digital data. This sampling frequency is matched with a time period denoted T_{E} in FIG. 4 and FIG. 16. More particularly, the sampling frequency in this case is an oversampling frequency, thus reflecting the oversampling applied by the analogue-to-digital converter to each bit of transmitted data. More particularly, at the end of the conversion, each bit of transmitted data will be represented by a number of bits recorded in a buffer memory 21, also referred to as a register, of the receiver 2, this number of bits being proportional to the oversampling frequency at which the analogue-to-digital converter operates. In other words, each bit transmitted is translated into a plurality of samples 23 in the register, each of which takes the form of a bit.

Thus, with reference to FIGS. 4 and 16, the processing method 200 according to the second aspect of the invention firstly comprises the step of sampling 210 the radio frequency signal received 205 at the oversampling frequency defined by the receiver 2, and then the step of recording 220, preferably progressively as the radio frequency signal is received 205 and converted, the samples 23 resulting from this conversion in the register 21 of the receiver 2. The registration step 220 can be carried out while also considering, where appropriate, a writing offset of the corresponding data in the register.

The non-zero conversion time and the potential difference in clock frequencies between the transmitter 1 and the receiver 2 explain, at least in part, and in any case impose, the need for frequency and phase synchronisation in order to be able to retrieve, by time synchronous averaging at the receiver 2, the digital data converted and transmitted 135 by the transmitter 1.

For this purpose, it is a prerequisite that the receiver 2 knows how the permutation of the digital data of the original block 10 was carried out at the transmitter 1. In other words, it is a prerequisite that the receiver 2 knows the algorithm and the parameters used to generate 120 the plurality of secondary blocks 20. It is also a prerequisite that the receiver 2 knows:
a) the number of bits comprised in the original data block 10,
b) the number of repetitions of the original data block 10 comprised in the data frame 22, and
c) the approximate number of samples 23 per bit of data transmitted, this number depending on the oversampling frequency of the receiver 2 and more particularly on a so-called nominal oversampling frequency of the receiver 2.

The manner in which the aforementioned prerequisites are ensured is known to a person skilled in the art. It is not required to differ from the way in which any prerequisites, which are identical to or different from those set out hereinabove, may need to be ensured according to the synchronisation methods of the prior art.

Knowing the aforementioned prerequisites, the receiver 2 is able to implement the steps described hereinbelow of the processing method 200 according to the second aspect of the invention.

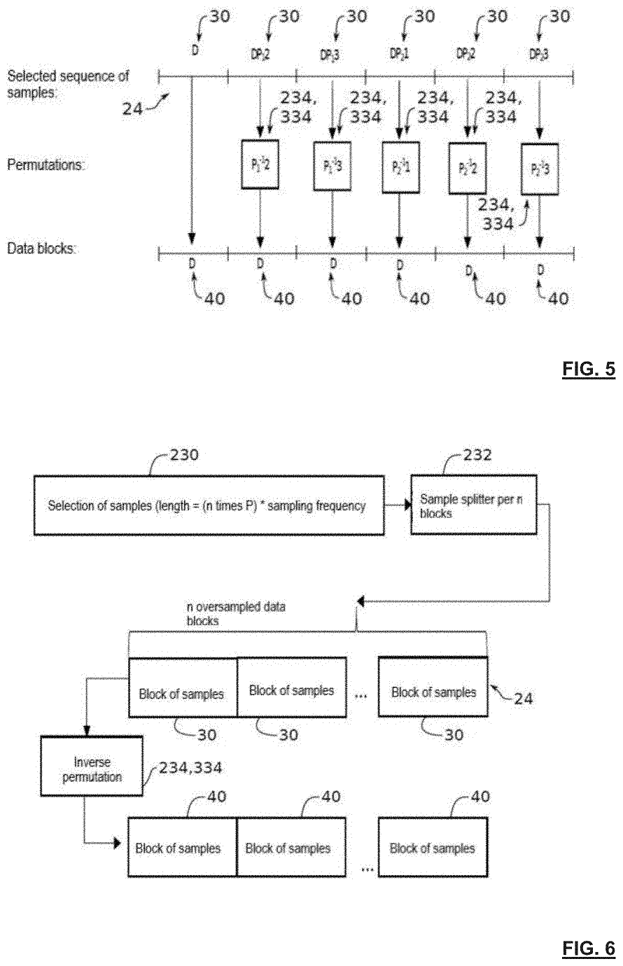

With reference to FIGS. 5 and 6, the processing method 200 comprises, preferably following the recording 220 of a series of samples having a size at least equal to the bit size of each secondary block 20 that is multiplied by the number of secondary blocks 20 in the data frame 22 and a presumed number of samples per bit selected from a set comprising a nominal value corresponding to the nominal oversampling frequency of the receiver, at least one value lower than the nominal value and at least one value higher than the nominal value, a step of selecting 230 a sequence of samples 24. More specifically, the selection 230 is firstly carried out:
a) for said presumed number of samples per bit, and
b) using a given sample 23 and at regular intervals of size equal to said presumed number of samples per bit.

The selection step 230 thus results in the definition of a first sequence of samples 24 having the bit size of the data frame 22. This first sequence of samples 24 is capable of representing the data frame 22, and thus the original data block 10.

In order to assess, or rather quantify, the level of representational viability of the first sequence of samples 24, the processing method 200 comprises the following steps, which consist of processing this first sequence of samples 24 selected 230.

As shown in FIG. 6, the processing of the first sequence of samples 24 firstly comprises a step of splitting 232 this sequence into a number of so-called tertiary blocks of samples 30, equal to the number of secondary blocks 20 comprised in the data frame 22.

At this stage, it is understood that each tertiary block 30 is capable of representing a corresponding secondary block 20 in the data frame 22. It should be reminded here that each secondary block 20 has been generated 120 at the transmitter 1 by a permutation of the bits, and more particularly of the sub-blocks of bits, of the original data block 10. Thus, in order for each tertiary block 30 to be representative of the original data block 10, a permutation must be applied thereto, which permutation is the inverse of that which led to the generation of the corresponding secondary block 20. This step is carried out by generating 234 a so-called quaternary block of samples 40 by permuting the samples of the tertiary block 30 with one another, this permutation being the inverse of that carried out on the original block 10 to obtain the corresponding secondary block 20. In FIG. 16, this step is shown as following the writing of the samples in the registers and as preceding a correlation measures step described hereinbelow. In FIG. 5, the exponent “−1” associated with each of the “Pₙ”-type notations reflects the notion of inverse permutation that has just been described. This thus results in a number of quaternary blocks 40 equal to the number of tertiary blocks 30.

Each quaternary block 40 is thus capable of representing the original data block 10. More particularly, each sample of each quaternary block 40 can be associated with an index, such that a sample of given index of the quaternary block is capable of representing a bit of the same index of the original block 10.

In order to quantify the level of viability of this representation, the processing method 200 firstly provides for dividing 236 the quaternary blocks 40 into at least two groups, and then computing 238 a so-called average block 50 for each group on the basis of the quaternary blocks 40 that this group comprises, in order to then be able to compute 240 a correlation measure 26 between each pair of average blocks 50.

The computation 238 of each average block 50 from the quaternary blocks 40 of a given group can be carried out, as shown in FIG. 7, by a simple arithmetic average of the samples associated with the same index among the samples comprised in the quaternary blocks 40 of the group. It should be noted in this case that each group does not necessarily comprise the same number of quaternary blocks 40.

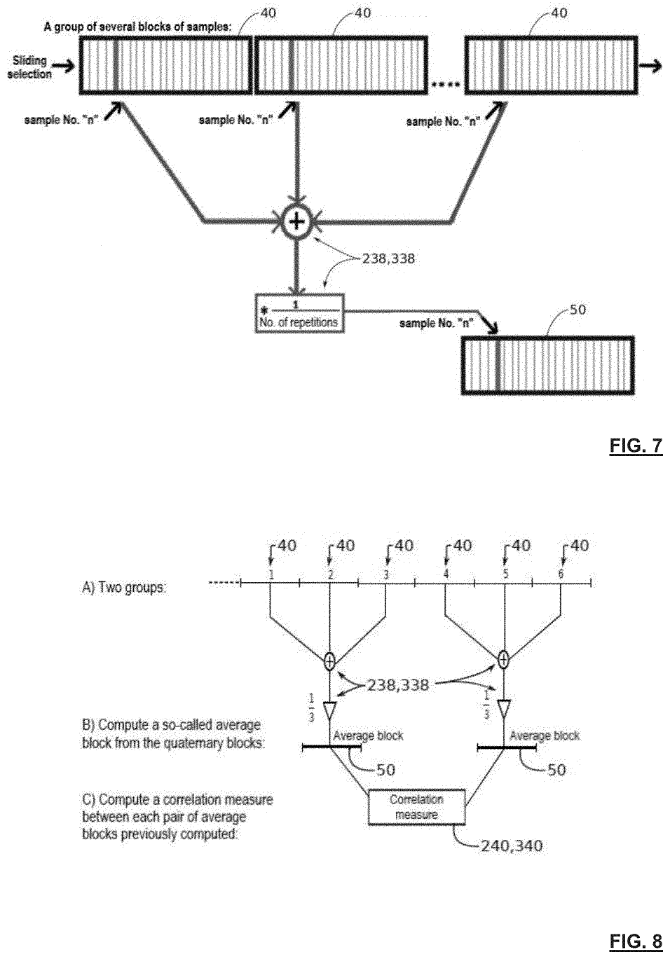

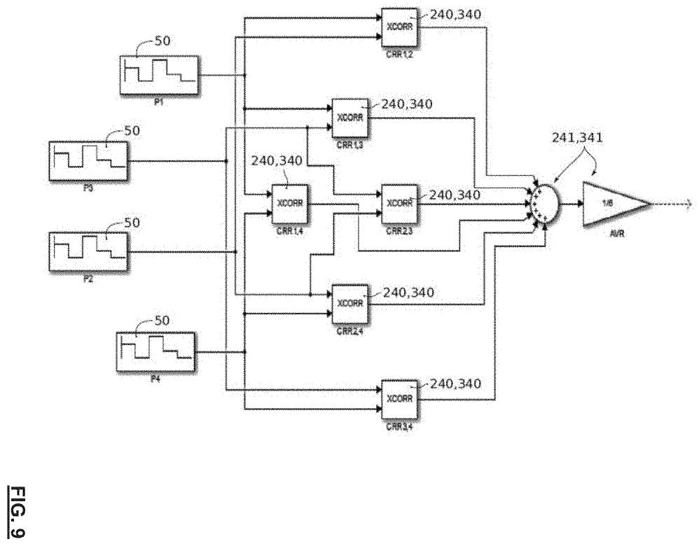

When the quaternary blocks 40 are divided 236 into two groups, the computation 240 of the correlation measure 26 is carried out between the two average blocks 50 that have been computed 238. This situation is that described in FIG. 8. Each computation 240 of the correlation measure 26 between two average blocks 50 is more particularly carried out according to an ad hoc algorithm known in the prior art. Several of these algorithms can be known, and a person skilled in the art is presumed to know how to select the most efficient and/or the most accurate therefrom, optionally according to a compromise in terms of computing resources and accuracy of the computation 240.

When the quaternary blocks 40 are divided 236 into more than two groups, the computation 240 of the correlation measure 26 is more complex. This situation is shown in FIG. 9, where four average blocks 50 have been computed 238 from the quaternary blocks 40 divided 236 into four groups. More particularly, FIG. 9 shows the multiple correlation technique which should then be applied to the four average blocks 50. Briefly, a correlation measure 26 is computed 240 between each pair of average blocks 50, for example in the same way as when the quaternary blocks 40 are divided 236 into two groups. For four average blocks 50, six pairs of average blocks 50 are to be considered. Thus, six correlation measures 26 are obtained, each corresponding to one of the six pairs of average blocks 50 to be considered. Then, on the basis of the six correlation measures 26 obtained, an arithmetic average is calculated, which reduces the six correlation measures 26 to a single correlation measure which will be used thereafter in the same way as the single correlation measure 26 obtained when the quaternary blocks 40 are divided 236 into two groups only. Thus, it is understood that, although the division of the quaternary blocks 40 into more than two groups complicates the computation 240 of the correlation measure 26 intended to be used in the subsequent steps of the processing method 200, these steps will be implemented in the same manner regardless of the number of groups into which the quaternary blocks 40 have been divided 236.

At this stage, a correlation measure 26 has thus been obtained which is intended, in the processing method 200, to be saved 242, for example in a storage medium of the receiver 2, by associating it on the one hand with the index of the sample 23 from which the first sequence of samples 24 was selected 230, and on the other hand with the presumed number of samples per bit considered, so that this correlation measure 26 can be used thereafter.

The quantification of the level of viability of the representation offered by the quaternary blocks 40 from the first sequence of samples 24 is not absolute, but is relative. It is in order to be able to compare this quantification with others, so as to be able to subsequently identify 270 a sequence of samples 24 as being the most representative of a succession of original data blocks 10 corresponding to the succession of secondary data blocks 20 from which the data frame 22 was constructed 130, that the processing method 200 provides for repeating 244 steps 230 to 242 using another sample different from the sample from which the first sequence of samples was selected, preferably until each sample recorded 220 in the register 21 has been considered as a starting sample for a selection 230. This iterative loop is represented in FIG. 16 by the arrow starting from the box representing a choice “Max?” as far as downstream of the box for the definition of the sampling frequency considered (represented here by the period T_{E}). For the same purpose, the processing method 200 further provides for repeating 250 all of the steps 230 to 244 for at least one other value of the presumed number of samples per bit, preferably until each value of the presumed number of samples per bit in the aforementioned set has been considered. This iterative loop is shown in FIG. 16 by the arrow from the box defining the need to consider an adjustment of the frequency, or equivalently of the T_{E} period, as far as the box defining the sampling frequency to be considered next.

It should be noted here that the order in which the starting samples of the different selections 230 to be carried out are considered and the order in which the values of the presumed number of samples per bit are considered are of little importance. It can be simpler, at least from a programming perspective, to traverse them in a certain order. For example, it appears simpler to firstly consider the first sample recorded in the register, then the second, etc. In another example, the starting samples and the values of the presumed number of samples per bit to be considered could also be randomly traversed, preferably excluding the consideration of the same pair of these parameters twice, such a consideration being unnecessary.

It should also be noted that the writing of the samples 23 in the register 21 can be carried out in either direction. Also in this sense, the order in which the transmitter 1 communicated the data frame 22 may need to be considered. More specifically, independently of the order of the data blocks in the register 21 of the receiver 2, the processing method 200 can be implemented using a sample at the start of the data frame or using the sample at the expected end of the data frame, in particular in view of the prerequisites stated hereinabove. In FIG. 16, this is shown by the box defining the potential need to distinguish between the start and end of the data frame.

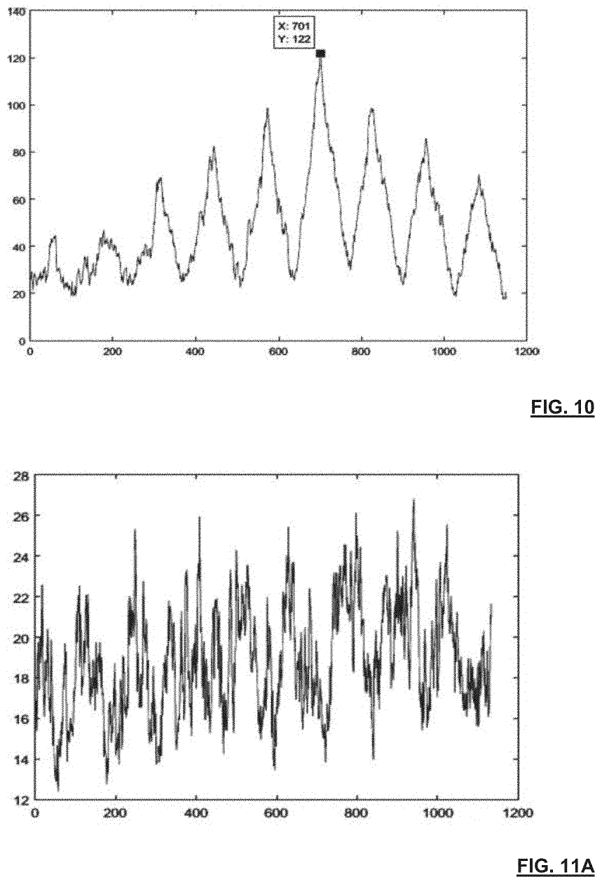

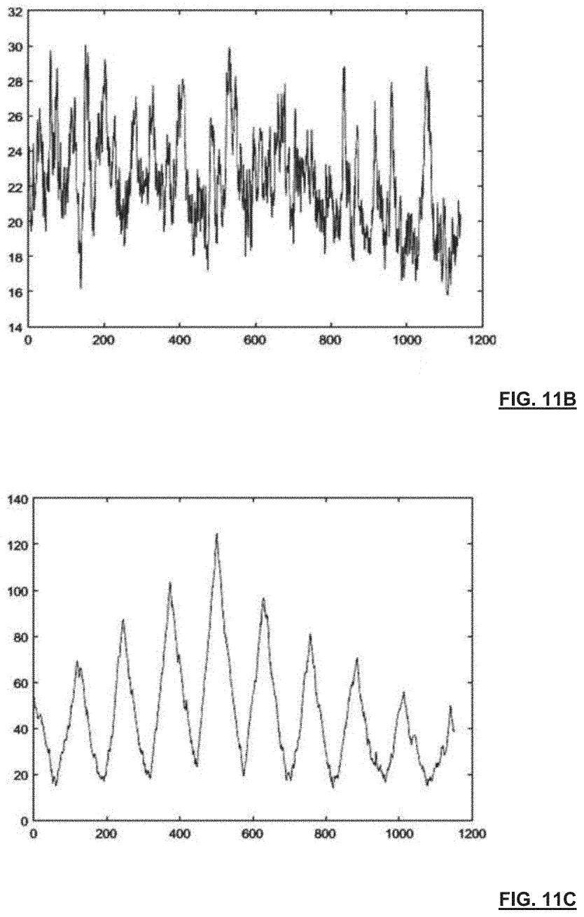

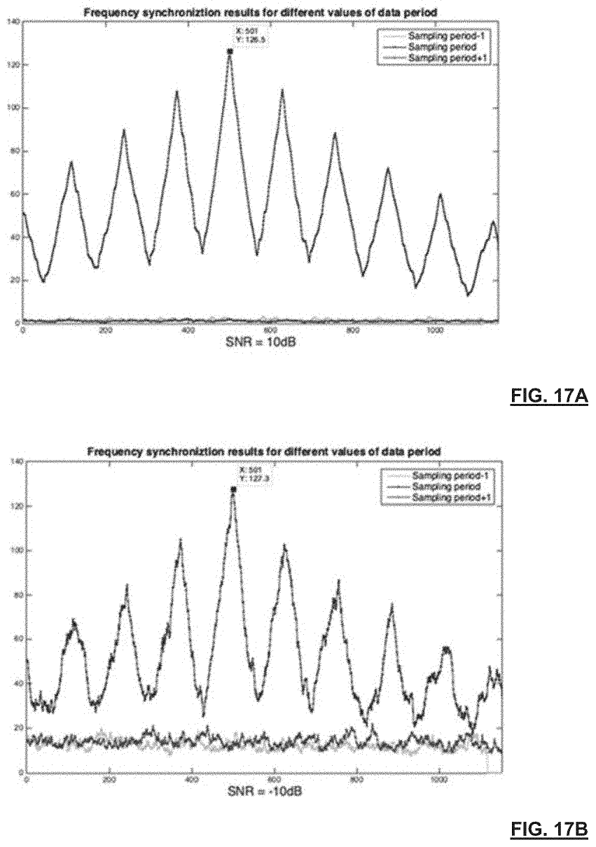

After considering each sample recorded 220 in the register 21 as a starting sample for a selection 230, a set of correlation measures 26 was obtained and which can be graphically represented as a function of the indices of the samples from which the selections 230 were made. Such a graphical representation is shown in FIG. 10, as well as in FIG. 11A to 11D and FIGS. 17A and 17B. These graphical representations were obtained by considering: an original data block 10 of 32 bits, forty repetitions of the original data block 10 and two groups of twenty repetitions to compute two average blocks. The data are presumed to be recorded in the buffer memory 21 of the receiver 2 at a nominal sampling frequency of four samples per bit. The graphs in FIGS. 10, 11A to 11D and 17A were obtained for a signal-to-noise ratio of 10 dB, whereas the graph in FIG. 17B was obtained for a signal-to-noise ratio of −10 dB.

Although such a graphical representation is not necessarily required in order to implement the processing method 200 according to the second aspect of the invention, this representation is provided here as it illustrates several advantages of the processing method 200. One of these advantages is to demonstrate the simplicity and robustness with which the processing method 200 can identify the sample index from which the most representative sequence of samples 24 was selected 230. In the example shown in FIG. 10, this sample, corresponding to the largest correlation measure 26 obtained by traversing a set of more than 1,100 starting samples from the selection 230, has the index 701. At this stage, the processing method 200 has allowed for phase synchronisation of the communication system 0. In other words, the method has enabled the detection of the start and/or end of the data frame 22 in the register 21 of the receiver 2.

It must now obtain the frequency synchronisation of the communication system 0.

It is this frequency synchronisation that can be obtained by considering each value from among the set of possible values of the presumed number of samples per bit.

FIG. 11A to 11D graphically show how the frequency synchronisation of the communication system 0 is obtained using the processing method 200. More particularly, each of these graphs plots the set of correlation measures 26 computed 240 as a function of the indices of the samples from which the selections 230 were made, for a value of the presumed number of samples per bit from among a set of four values, the graph of FIG. 11A having been obtained for a presumed number of samples per bit equal to 126, the graph in FIG. 11B having been obtained for a presumed number of samples per bit equal to 127, the graph in FIG. 11C having been obtained for a presumed number of samples per bit equal to 128, and the graph in FIG. 11D having been obtained for a presumed number of samples per bit equal to 129. Such graphical representations are not necessary when implementing the processing method 200 according to the second aspect of the invention, but are provided to again illustrate the simplicity and robustness with which the processing method 200 enables the communication system 0 to be frequency synchronised.

By comparing the graphs shown in FIG. 11A to 11D with one another, and in particular by comparing the maximum ordinate values reached by the correlation measures 26 plotted in these graphs, it is immediately apparent that these maximum values are lower than 32 on the graphs of FIGS. 11A, 11B and 11D, whereas the maximum value reached on the graph of FIG. 11C is higher than 120. It is thus understood that the value of the number of samples per bit to be considered as providing the best frequency synchronisation of the communication system 0 is equal to 128, according to the example shown.

The manners described hereinabove in which the processing method 200 according to the second aspect of the invention achieves phase and frequency synchronisation of the communication system 0 can be summarised as consisting of determining 260, from among the correlation measures 26 saved 242, the correlation measure 26 that corresponds to the highest correlation between average blocks 50, and of retrieving 262 the sample index and the presumed number of samples per bit associated with this maximum correlation measure 26. The selection of samples 24 selected from the index associated with the maximum correlation measure 26 and at regular intervals of a size equal to the presumed number of samples per bit associated with this maximum correlation value 26 can be identified 270 as being representative of a succession of original data blocks corresponding to the succession of secondary data blocks from which the data frame 22 was constructed 130.

At this stage, it is thus possible to determine 280 the digital data presumed to correspond to those originally grouped 110 into the original block 10 by carrying out time synchronous averaging over the sequence of samples 24 identified 270. In order to carry out this time synchronous averaging, the sample sequence identified 270 can be selected 230 again, in the register, but equivalently, the results of a certain number of the steps of the processing method 200 according to the second aspect of the invention, and in particular the average blocks 50 computed 240 can also have been saved in order to be used for this purpose.

The communication technique combining the implementation of the method 100 for processing digital data according to the first aspect of the invention and the method 200 for processing a radio frequency signal according to the second aspect of the invention provides for the injection, at the transmitter 1, and the use, at the receiver 2, of information in addition to the data to be communicated for the synchronisation between the transmitter 1 and the receiver 2 of the communication system 0. The proposed communication technique is based not only on the retransmission of the same data by the transmitter 1, but also on the permutation of the original data blocks 10 before the communication thereof. It is the permutation of the data that constitutes most, if not all, of said additional information.

This last point at least distinguishes the synchronisation method used here from the synchronisation methods of the prior art, the latter being essentially based on the use of signals external to the data signal, these external signals comprising, for example, a preamble word.

The permutation of the original data blocks 10 before the communication thereof ensures that, at the receiver 2, the correlation measures 26 carried out allow for accurate phase and frequency synchronisation. Phase synchronisation is achieved by identifying the start and/or end of the frame (in the buffer memory) carrying the information to be communicated in a repeated and then permuted manner. Frequency synchronisation is achieved by detecting the effective number of samples per bit. This number depends on the oversampling frequency at the receiver 2 and the bit-time is defined by a local oscillator at the transmitter 1. This precise synchronisation ultimately allows the data to be communicated to be retrieved by time synchronous averaging, even when the data are significantly noisy.

The communication technique proposed in this case thus uses the fact that the data signal is periodically repeated, without requiring the use of synchronisation data external to the data signals to be communicated. It enables phase and frequency synchronisation to be maintained, even when receiving very noisy signals, including signals with a signal-to-noise ratio of less than 1 or even a negative signal-to-noise ratio (in decibels (dB)).

FIGS. 17A and 17B show that the communication technique proposed in this case is effectively very robust with respect to variations in the signal-to-noise ratio. More particularly, while the graph in FIG. 17B was obtained for a much higher noise than the graph in FIG. 17A, it can be seen that the communication technique proposed in this case identifies the same sample (in this case sample 501) and the same sampling period (in this case a “sampling period” equal to 4, relative to a “sampling period−1” equal to 3 and a “sampling period+1” equal to 5).

There is thus only one sampling rate for which the correlation measure detects similarity between the repeated data blocks. In the graphs shown in FIGS. 17A and 17B, the variation in the signal-to-noise ratio (SNR) is equal to 20 dB. However, in both cases, the communication technique proposed here allows for phase and frequency synchronisation with a high degree of accuracy. It can be concluded that the method presented is extremely robust to noise variations.

It significantly improves the processing gain of the time synchronous averaging method ultimately used. More specifically, at a constant transmission power, the energy of the data signal increases proportionally to the number of repetitions, the operationally allowable limit whereof is in this case extended compared to the techniques of the prior art. This communication technique actually allows time synchronous averaging to be applied operationally to a greater number of repetitions than in the techniques of the prior art, under the same transmission conditions. The detection and processing of very noisy or very low amplitude periodic signals with the time synchronous averaging method is advantageously made possible. Moreover, bandwidth savings are achieved, for a constant number of repetitions, compared to the techniques of the prior art.

A person skilled in the art will appreciate that the communication technique proposed here further allows for:
a) increasing the sensitivity of the communication system 0, and/or
b) improving the link budget, and/or
c) increasing the communication distance of the system 0, and/or
d) ensuring bi-directional communication, for example for Internet of Things applications, while maintaining a radio frequency signal power level that complies with the communication regulations (ETSI, FCC, etc.), and/or
e) increasing the number of repetitions of the original data block, to avoid having to increase the power of the RF signal transmitted.

The invention is not limited to the aforementioned embodiments, and includes all the embodiments covered by the claims.

In particular, an alternative embodiment of the second aspect of the invention is proposed, wherein the iterative loop on the given sample from which the sequence of samples 24 is selected 330 and the iterative loop on the number of samples presumed per bit are traversed in a different manner to those set out hereinabove. A person skilled in the art will recognise that, in addition to this alternative embodiment, the above-mentioned loops can be traversed in various other ways. More specifically, one or more starting samples can be considered in an equivalent manner in order to carry out the selection 230, 330 of the aforementioned sequence of samples 24, then one or more values of the presumed number of samples per bit can be considered, before considering one or more others of said starting samples, etc. Thus, a wide range of possibilities for nesting the aforementioned loops with one another can be conceived. Furthermore, from this wide range of possibilities, a choice can be guided, either automatically or by an operator, in order to achieve an acceptable or even optimal result, without necessarily having to traverse both of the two loops mentioned hereinabove.

Furthermore, it should be noted that the data relating to the frequency synchronisation of the communication system 0, which data have been extracted from the received radio frequency signal 205 and are related to the initial permutation of the digital data to be communicated, are in general relatively stable, and in particular more stable than the data relating to the phase synchronisation of the communication system 0. This phenomenon can be exploited as follows: other digital data to be communicated at a later stage, at least within a few days at most, will be able to be processed 200 using the frequency synchronisation data extracted from the previous digital data communicated.

1. A method for processing digital data to be transmitted in the form of a radio frequency signal from a transmitter to a receiver, the processing method comprising the following steps of:
a) Grouping the digital data into a so-called original data block with a determined bit size,
b) Generating, from the original data block, a plurality of so-called secondary data blocks, each secondary data block being obtained by permutation, according to an algorithm and determined parameters, of the digital data grouped into the original block, the algorithm and the parameters being chosen so as to minimise the correlation between the secondary blocks of the plurality, and
c) Constructing a data frame comprising a succession of a determined number of secondary blocks from the plurality of secondary blocks previously generated, the frame thus constructed defining the radio frequency signal to be transmitted.

2. The processing method according to the preceding claim, wherein the data frame (22) comprises only said succession of secondary blocks (20), and is free of other data such as data constituting a preamble word.

3. The processing method according to claim 1, wherein the secondary data blocks of the data frame are adjacent to one another in pairs.

4. The processing method according to claim 1, wherein the step of generating a plurality of secondary data blocks comprises the sub-steps of:
a) Splitting the original data block into at least three sub-blocks such that at least one sub-block comprises at least two bits, with at least two sub-blocks potentially comprising a different number of bits, and
b) Permuting the sub-blocks with one another,
these sub-steps capable of being repeated while varying the number of sub-blocks and/or the number of bits in at least two sub-blocks.

5. A method for processing a radio frequency signal received by a receiver, the radio frequency signal having been defined from a data frame comprising a succession of a determined number of so-called secondary data blocks, each secondary data block having been obtained by permutation, according to an algorithm and determined parameters, of digital data previously grouped into a so-called original block having a determined bit size, the processing method comprising the following steps of:
a) Sampling the radio frequency signal with an oversampling frequency defined by the receiver,
b) Recording the samples as they are taken into a buffer memory,
c) From among a series of recorded samples having a size at least equal to the bit size of each secondary block that is multiplied by the number of secondary blocks in the data frame and for a presumed number of samples per bit selected from a set comprising a nominal value corresponding to a nominal oversampling frequency of the receiver, at least one value lower than said nominal value and at least one value higher than said nominal value:
i. (1) Selecting a sequence of samples from a given sample at regular intervals of size equal to said presumed number of samples per bit or (2) selecting a sequence of samples at regular intervals of size equal to said presumed number of samples per bit,
ii. Splitting (232) the selected sequence of samples into a number of so-called tertiary blocks of samples equal to the number of secondary blocks in the data frame,
iii. For each tertiary block (30), generating a so-called quaternary block of samples by permuting the samples of the tertiary block with one another, this permutation being the inverse of that carried out on the original block to obtain the corresponding secondary block, then
iv. Dividing the quaternary blocks into at least two groups,
v. Computing, per group, a so-called average block from the quaternary blocks,
vi. Computing a correlation measure between each pair of previously computed average blocks,
vii. Saving the one or more previously computed correlation measures by associating each correlation measure with an index of the sample from which the selection was made and with the presumed number of samples per bit, then
viii. (1) Repeating steps i to vii using at least one other sample different to the sample from which the previous selection was made or (2) repeating steps i to vii, for at least one other value of the presumed number of samples per bit different to that with which the previous selection was made, respectively,
d) (1) For at least one further value of the presumed number of samples per bit selected from among the set comprising a nominal value corresponding to a nominal oversampling frequency of the receiver, at least one value lower than said nominal value and at least one value higher than said nominal value, repeating step c, so as to save the correlation measures computed, associating each correlation measure with the index of the sample from which the selection was made and with the presumed number of samples per bit considered, or (2) repeating step c from at least one other sample different to the sample previously considered, so as to save the correlation measures computed, associating each correlation measure with the index of the sample from which step c is repeated and with the presumed number of samples per bit considered, respectively,
e) Determining which correlation measure of the correlation measures saved corresponds to a higher correlation between average blocks, and retrieving the index of the sample and the presumed number of samples per bit associated with this correlation measure, then
f) Identifying the sequence of samples selected from the index of the sample associated with this correlation measure and at regular intervals of size equal to the presumed number of samples per bit associated with this correlation measure, as being representative of a succession of original data blocks corresponding to the succession of secondary blocks from which the data frame was constructed.

6. (canceled)

7. The processing method according to claim 5, wherein said given sample is initially the first sample recorded in the buffer memory.

8. The processing method according to claim 5, wherein steps i to vii are repeated using a sample following the sample from which the previous selection was made.

9. The processing method according to claim 5, wherein step c is repeated using a sample following the sample from which steps i to vii were previously repeated.

10. The processing method according to claim 5, wherein, with the quaternary blocks being divided into more than two groups, the step of computing at least one correlation measure between each pair of average blocks previously computed further comprises computing a correlation measure by averaging the correlation measures between pairs of average blocks.

11. The processing method according to claim 5, wherein step f is followed by a step of determining digital data by time synchronous averaging for the sequence of samples identified in step f.

12. (canceled)

13. A non-transitory computer readable medium storing instructions, which when performed by at least one processor, executes at least the steps of the processing method according to claim 1.

14. (canceled)
